(19) United States
(12) Patent Application Publication
(10) Pub. No.: US 2011/0029343 A1
(43) Pub. Date: Feb. 3, 2011

(54) APPOINTMENT ALERT SYSTEM AND METHOD

(76) Inventors: Edward DARREFF, Statesboro, GA (US); Margaret DARREFF, Statesboro, GA (US)

Correspondence Address: LAW OFFICE OF JERRY D. HAYNES , P.A, P.O. Box 350392, Fort Lauderdale, FL, 33335, US

(21) Appl. No.: 12/512,990

(22) Filed: Jul. 30, 2009

(51) Int. Cl. G06Q 10/00; G06F 15/16

(52) U.S. Cl. 705/8; 709/217

(57) ABSTRACT

The present invention relates to a system and method of alerting clients of the status of a scheduled appointment comprising the steps of: accepting an appointment from a client; logging the appointment time into an electronic calendar; transmitting an appointment reminder to the client; transmitting an appointment status alert to the client on the day of the scheduled appointment; and providing the client with the option to reschedule the scheduled appointment. If the client should elect to reschedule after receiving the appointment status alert, the client's new appointment time is logged into the electronic calendar. The appointment reminder and appointment status alert according to the present invention is transmitted over a communications network, where the communications network may be either the Internet and/or a wireless communications network. The client may receive the appointment reminder and appointment status alert on a cell phone, a smart phone or a telephone.

### BACKGROUND OF THE INVENTION

b 1. Field of Invention

The present invention relates to an appointment alert system to notify clients of scheduling potential delays related to the scheduled appointment.

2. Description of Related Art

Scheduling of medical appointments or other business appointments is a concern of many individuals especially with respect to medical appointments due to the increased availability of healthcare in recent years. Many healthcare providers must schedule more patients than time allowed due to the high demand of healthcare. Some medical providers simply have a high volume of patients and consequently scheduling and maintaining a schedule throughout a day can be a challenging endeavor. Although numerous computer-based and electronic-based systems are available to schedule clients occasionally these means of scheduling are either not used effectively or misused and cause scheduling conflicts and overbooking of clients.

Some systems have been developed in order to alert a patient or a client of an upcoming appointment with a medical provider or other business entity. These alerting systems may send a message or actually call the patient with a recorded message reminding the patient of an upcoming appointment. In particular, U.S. Pat. No. 5,872,505 discloses a patient alert system that assists patients with treatment reminders and appointment times. The patient alert system of the ‘505 patent principally alerts patients of treatment schedules related to prescribed medicine but also alerts patients of upcoming appointments scheduled with their medical provider.

Although the prior art includes such alerting systems as described above which provide reminders of pending appointments, the communication systems of the prior art do not provide clients with real time status updates related to a scheduled appointment. Although an appointment may be scheduled in advance as stated some medical providers overbook or have such a high volume of patients that the schedule becomes off track during a typical day. It would be advantageous to have a system that alerts a client of a backlog developing at a medical provider's office in order to give the client an option to reschedule the appointment. Such a system could alleviate some of the overbooking and scheduling problems that may arise during the day and alleviate the client of the frustration of waiting an extended period of time due to scheduling problems.

### SUMMARY OF THE INVENTION

The present invention relates to a system and method of alerting clients of the status of a scheduled appointment comprising the steps of: accepting an appointment from a client; logging the appointment time into an electronic calendar; transmitting an appointment reminder to the client; transmitting an appointment status alert to the client on the day of the scheduled appointment; and providing the client with the option to reschedule the scheduled appointment. If the client should elect to reschedule after receiving the appointment status alert, the client's new appointment time is logged into the electronic calendar and place in position to receive a reminder and status alerts based on the new time. The appointment reminder and appointment status alert according to the present invention is transmitted over a communications network, where the communications network may be either the Internet and/or a wireless communications network. The client may receive the appointment reminder and appointment status alert on a cell phone, a smart phone or a telephone.

### BRIEF DESCRIPTION OF DRAWINGS

FIG. 1 provides an overview of an appointment alert system according to the present invention.

FIG. 2 provides a flowchart of the steps related to the appointment alert system according to the present invention.

### DETAILED DESCRIPTION

The present invention relates to a system and method of appointment alerting and updating to assist in managing appointment schedules at a medical provider or other business which requires scheduled appointments. The purpose of this appointment alert system is to alert clients and patients of delays and possible cancellations related to an appointment schedule at a medical provider or any other appointment based business. The objective of the alert system and method is to alleviate the frustration that may be associated with delayed appointments at medical providers or other businesses that regularly schedule clients throughout the day.

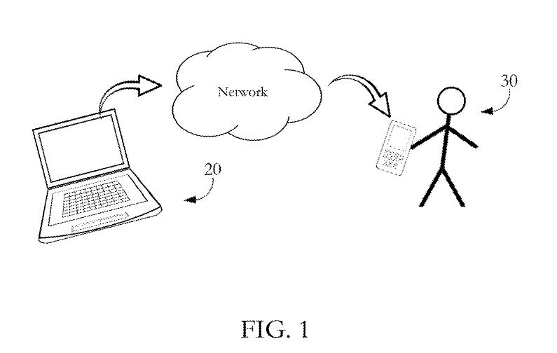

FIG. 1 depicts an overview of an alerting system according to the present invention. Communications Network 10 is depicted which provides the means to transmit messaging alerts to a scheduled Client 30. The messaging alerts are transmitted from a Computer 20 as depicted in FIG. 1 over the Communications Network 10 and then received by the Client 30 via a personal communications device such as a cellular phone, smart phone or similar device that can receive a call, SMS message or email alert system. This system provides a means for medical personnel who may be at the medical provider's office to alert clients of appointment delays and cancellations.

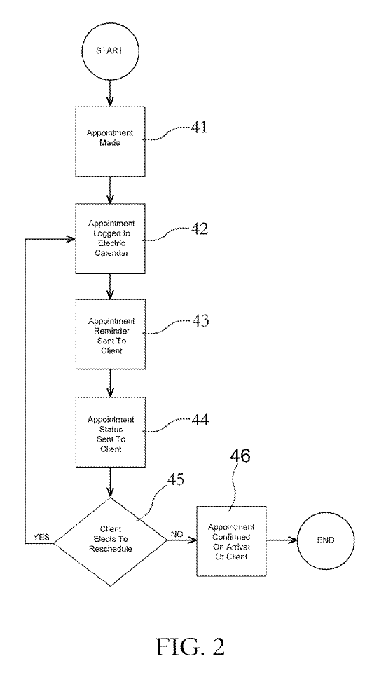

FIG. 2 depicts a flowchart of steps related to the appointment alerting system according to the present invention. Initially, a client makes an appointment, Step 41, this may be done in any of the conventional manners that a client may make an appointment with a medical provider or other type of business. The appointment is logged into an electronic calendar, Step 42, which stores information related to the appointment schedule for a particular business or medical provider. Under Step 43, an appointment reminder is sent to a client prior to the scheduled date of the appointment. This alerting system at this point gives the client a simple reminder at a pre-determined time period before the scheduled appointment. On the day of the appointment the appointment status alert is sent to the client, Step 44. This feature allows a business or a medical provider to send appointment status updates to clients on a periodic basis throughout the day of the scheduled appointment. Consequently initial appointments of the day may not receive any status updates or simply an on-time alert, since ideally these appointments are within the first hour or two of the business day. However after the initial appointments, alerts are provided for subsequent clients that may have a scheduled appointment later in the day.

The alert system according to the present invention provides patients with an alert that their scheduled appointment is on time as expected or due to circumstances the actual appointment time is moved back to a later point in the day or it may alert the client that a cancellation has occurred and an earlier time period may be available for the client to change.

After receiving the appointment status alert from the business or medical provider, the client may elect to reschedule the appointment, Step 45. Should the client elect to reschedule then the appointment change is logged into the electronic calendar and the reminder status alerts will be scheduled in accordance with the pre-determined time periods associated with the system. Should the client elect not to reschedule the appointment then the appointment will be confirmed upon arrival of the client at the place of business or medical provider.

The patient alert system and method according to the present invention provides appointment notifications in real time on the day of the actual appointment in order to provide clients with the ability of rescheduling the appointment. Also if a client is alerted that the appointment may actually occur at a later time the client can use this time to adjust their schedule appropriately in order to accommodate the change appointment time. The alerts are sent to the client's cell phone, smart phone or personal digital assistant via a message that is transmitted over an existing communications network. The communications network may include the Internet, wireless communications networks established by wireless services or if so desired to an individual's home phone number. The alerting system and method according to the present invention is a system that has the potential to increase client satisfaction and allow clients maximum flexibility in scheduling appointments.

What is claimed is:

1. A method of alerting clients of the status of a scheduled appointment comprising the steps of:
a. accepting an appointment from a client;
b. logging the appointment time into an electronic calendar;
c. transmitting an appointment reminder to the client;
d. transmitting an appointment status alert to the client on the day of the scheduled appointment; and
e. providing the client with the option to reschedule the scheduled appointment.

2. The method of alerting clients according to claim 1, where said appointment reminder and appointment status alert is transmitted over a communications network.

3. The method of alerting clients according to claim 2, where said communications network includes at least one of the Internet and wireless communications network.

4. The method of alerting clients according to claim 1, where the client receives the appointment reminder and appointment status alert on at least one of a cell phone, a smart phone and a telephone.

5. The method of alerting clients according to claim 1, where said electronic calendar is stored within the memory of a computer database.

6. The method of alerting clients according to claim 1, where the step of transmitting an appointment reminder to the client, is initiated at a pre-determined time period prior to the scheduled appointment.

7. The method of alerting clients according to claim 1, where the appointment status alert is sent periodically through the day of the appointment in real time.

8. The method of alerting clients according to claim 1, including the further steps of:
a. reescheduling the client's appointment, if the client should elect to reschedule after receiving the appointment status alert; and
b. logging the client's new appointment time into the electronic calendar.
